(19) United States
(12) Patent Application Publication
(10) Pub. No.: US 2012/0109733 A1
(43) Pub. Date: May 3, 2012

(54) METHOD AND SYSTEM FOR PROVIDING DYNAMIC MARKETING DEVICES BASED ON "REAL-TIME" DATA

(76) Inventors: Colin J. Roper, San Francisco, CA (US); Terry Hicks, San Mateo, CA (US)

(21) Appl. No.: 12/916,115

(22) Filed: Oct. 29, 2010

(51) Int. Cl. G06Q 30/00

(52) U.S. Cl. 705/14.25

(57) ABSTRACT

A method and system for providing dynamically customized marketing devices using real-time consumer data whereby shopping analytics data associated with a consumer regarding a consumer's current purchase related activity is monitored and/or collected. The shopping analytics data associated with the consumer is then used to automatically modify, and/or create, the terms of a mobile coupon, or other marketing device, and present the transformed mobile coupon, or other marketing device, to the consumer, in relative real-time, and in response to changing circumstances indicated by the shopping analytics data associated with the consumer.

### BACKGROUND

Many providers of consumer goods and services, and other advertisers, herein collectively referred to as marketing device providers, offer marketing devices, such as coupons, promotional and/or discount certificates, price guarantees, and vouchers, to consumers in an effort to attract and/or encourage business.

Traditionally, marketing devices have been distributed as “hard-copy” coupons, typically in printed, form, by various means, including, but not limited to: by mail; in newspapers; in magazines; in flyers and inserts; at store fronts and/or product displays; and/or as attachments to store receipts (i.e., printed on the back of a receipt or appended to a receipt).

More recently, marketing devices have been offered/distributed using electronic means such as, but not limited to: networks of computing systems, including public networks such as the Internet; mobile networks and computing systems, such as smart phones; various advertising/coupon web-sites; e-mail; electronic coupon attachments to electronic receipts; and electronic coupon attachments to, transactional data, such as, but not limited to transactional data from and/or displayed by, banks, credit card companies, and other financial institutions.

In addition, even more recently, “mobile coupons” have become increasingly popular. Using mobile coupons, a marketing device is made available to, and/or delivered to, a consumer via a display device on one or more mobile computing systems, or other mobile devices. In many instances, once a mobile coupon is made available, or delivered, to the consumer via the display device, the mobile coupon is also presented to a seller of products and/or services, and/or is used, by displaying the mobile coupon to a merchant via the display device on the one or more mobile computing systems, or other mobile devices, or by another form of data transfer.

Herein, the terms “coupon” and “marketing device” are used interchangeable to include traditional and/or electronic marketing devices, mobile coupons/marketing devices, virtual coupons/marketing devices offered as screen displays on computing systems, promotional certificates, vouchers, discount certificates, discount vouchers, sales offers, advertisements, and/or any other marketing tool and/or device, distributed by any distribution means, as discussed herein, and/or as known in the art at the time of filing, and/or as developed after the time of filing.

Many marketing devices offer significant discounts to the consumer holding, and meeting the terms of, the marketing device. Therefore, marketing devices can represent a significant expense to the marketing device provider. Typically, the marketing device provider is willing to incur this expense to meet specific goals, including, but not limited to: to help build up a customer base; to get consumers into a store; to retain customers who find a lower price for an item from a competitor; to lure customers away from a competitor; and/or to help clear excess inventory and/or to boost sales of a given product. In addition, many marketing device providers desire not only to attract new and returning consumers but they also want to encourage consumers to spend more on their products and services.

Currently, marketing devices, including mobile coupons, are largely static in that, once generated and distributed, the terms/offers of the marketing devices do not change to adapt to dynamic circumstances or specific consumer data. Consequently, using currently available marketing devices, marketing device providers must try to predict consumer behavior and capture as many “average” consumers as possible by defining generalized marketing device terms/offers in advance of their distribution and/or use. Therefore, currently, many marketing devices fail to address the needs of a given consumer and are incapable of taking advantage of the modern information/data rich environment by adapting to, and/or responding to, changing conditions. This situation is less than ideal for both the marketing device providers and the consumers.

### SUMMARY

In accordance with one embodiment, a method and system for providing dynamically customized marketing devices using real-time consumer data includes a process for providing dynamically customized marketing devices using real-time consumer data whereby, in one embodiment, shopping analytics data associated with a consumer regarding a consumer's current purchase related activity, such as, but not limited to, marketing offer searches recently made by the consumer, marketing offers recently viewed by the consumer, recent marketing offer downloads made by the consumer, recent marketing offer redemptions made by the consumer, network searches recently conducted by the consumer, and/or current GPS/location data for the consumer, is monitored and/or collected. In one embodiment, the shopping analytics data associated with the consumer is then used to automatically transform, i.e., modify, and/or create, the terms of a mobile coupon, or other marketing device, and present the transformed mobile coupon, or other marketing device, to the consumer, in relative real-time, and in response to changing circumstances indicated by the shopping analytics data associated with the consumer.

Using the method and system for providing dynamically customized marketing devices using real-time consumer data discussed herein, a consumer is provided mobile coupons, or other marketing devices, whose terms are dynamically transformed, in real time, to more closely meet the identified needs of that consumer's present situation. Consequently, using the method and system for providing dynamically customized marketing devices using real-time consumer data discussed herein, marketing device providers can provide marketing devices that are more likely to address the needs of a given consumer and are more likely to be used by the given consumer.

### BRIEF DESCRIPTION OF THE DRAWINGS

FIG. 1 is a block diagram of an exemplary hardware architecture for implementing one embodiment; and

FIG. 2 is a flow chart depicting a process for providing dynamically customized marketing devices using real-time consumer data in accordance with one embodiment.

Common reference numerals are used throughout the FIG.s and the detailed description to indicate like elements. One skilled in the art will readily recognize that the above FIG.s are examples and that other architectures, modes of operation, orders of operation and elements/functions can be provided and implemented without departing from the characteristics and features of the invention, as set forth in the claims.

### DETAILED DESCRIPTION

Embodiments will now be discussed with reference to the accompanying FIG.s, which depict one or more exemplary embodiments. Embodiments may be embodied in many different forms and should not be construed as limited to the embodiments set forth herein, shown in the FIG.s, and/or described below. Rather, these exemplary embodiments are provided to allow a complete disclosure that conveys the principles of the invention, as set forth in the claims, to those of skill in the art.

In accordance with one embodiment, a method and system for providing dynamically customized marketing devices using real-time consumer data includes a process for providing dynamically customized marketing devices using real-time consumer data whereby, in one embodiment, data related to the shopping activities of a given consumer is collected, and/or monitored, in one embodiment, via a mobile computing system, or other computing system, associated with the given consumer.

In one embodiment, the data related to the shopping activities of a given consumer collected includes, but is not limited to, one or more of the following: data indicating the marketing device/offer searches the consumer has recently conducted, and/or is conducting, using the mobile computing system, or other computing system, associated with the consumer; data indicating the marketing devices/offers the consumer has recently accessed, viewed, and/or downloaded, and/or is currently accessing, viewing, and/or downloading using the mobile computing system, or other computing system, associated with the consumer; data indicating recent marketing device/offer redemptions made by the consumer, and/or redemptions currently being made by the consumer, using the mobile computing system, or other computing system, associated with the consumer; data indicating network and/or website searches recently conducted by, or being conducted by, the consumer using the mobile computing system, or other computing system, associated with the consumer; data indicating historical purchase behavior/events associated with the consumer involving the current merchant and/or product or other merchants and/or products; data indicating various financial data associated with the consumer, such as, but not limited to, income, historical spending in various categories; data indicating a date and/or time of day; camera and/or other video data currently, or recently, recorded by the consumer using the mobile computing system, or other computing system, associated with the consumer, including but not limed to barcode data and/or image recognition data; data indicating the consumers distance from alternative merchants and/or products; and/or current GPS/location data for the consumer obtained from, or provided to, the mobile computing system, or other computing system, associated with the consumer.

In one embodiment, data related to the shopping activities of a given consumer is collected, obtained, and/or monitored using one or more processors associated with one or more computing systems. In one embodiment, data related to the shopping activities of a given consumer is collected, obtained, and/or monitored via a network of one or more computing systems.

In one embodiment, the collected/obtained data related to the shopping activities of the given consumer is analyzed to transform the raw data into current shopping analytics data associated with the consumer regarding the consumer's current purchase related activity, such as, but not limited to: what types of products the consumer is currently considering purchasing; products related to the types of products the consumer is currently considering purchasing; what marketing devices and/or offers are currently being offered to, and/or considered by, the consumer; the terms of the marketing devices and/or offers currently being offered to, and/or considered by, the consumer; the physical location of the consumer; how close the consumer is to actually making a purchase decision; how carefully the consumer is considering a given purchase and how interested the consumer is in a given product or service.

In one embodiment, the collected/obtained data related to the shopping activities of the given consumer is analyzed and transformed into current shopping analytics data associated with the consumer regarding the consumer's current purchase related activity using one or more processors associated with one or more computing systems.

In one embodiment, the current shopping analytics data associated with the consumer is then used to automatically transform, i.e., modify, and/or create, a mobile coupon, or other marketing device, and/or transform, define, or re-define, the terms of a mobile coupon, or other marketing device, in relative real-time with, and in response to circumstances indicated by the current shopping analytics data associated with the consumer.

In one embodiment, the current shopping analytics data associated with the consumer is used by one or more processors associated with one or more computing systems to transform, modify, and/or create, the mobile coupon, or other marketing device, into a transformed mobile coupon, or other marketing device.

In one embodiment, the transformed mobile coupon, or other marketing device, is then provided to the consumer, in one embodiment, through the mobile computing system, or other computing system, associated with the given consumer.

In one embodiment, the transformed mobile coupon, or other marketing device, is provided to the consumer via one or more processors associated with one or more computing systems. In one embodiment, the transformed mobile coupon, or other marketing device, is provided to the consumer via a network of one or more computing systems. In one embodiment, the transformed mobile coupon, or other marketing device, is provided to the consumer via a database, website, or web-based system. In various embodiments, the transformed mobile coupon, or other marketing device, is provided to the consumer using any method, means, process, and/or procedure for transferring data, as discussed herein, and/or as known in the art at the time of filing, and/or as developed after the time of filing.

As one illustrative example, assume a given consumer opens up a marketing device access application, such as a mobile coupon application, on the consumer's smart phone, or other mobile computing system. Then the consumer clicks, or otherwise activates, a marketing device/coupon offering $10-off a first brand of HD TV. Using the process for providing dynamically customized marketing devices using real-time consumer data discussed herein, this data related to the shopping activities of the consumer, i.e., data indicating the marketing devices/offers the consumer has recently accessed, viewed, and/or downloaded, and/or is currently accessing, viewing, and/or downloading using the mobile computing system, or other computing system, is collected and is analyzed and transformed into current shopping analytics data associated with the consumer indicating the consumer is contemplating the purchase of the HD TV. Then, in this specific illustrative example, a marketing device is generated that includes an offer of a $20.00 discount if the consumer purchases both the HD TV and an HD DVD. Then, in this specific illustrative example, the created/transformed marketing device is provided to the consumer through the consumer's mobile computing system, or other computing system.

As another specific example, assume a given consumer is in a first electronics store and sees a first brand HD TV for sale for $300.00. Further assume the given consumer opens up a marketing device access application, such as a mobile coupon application, on the consumer's smart phone, or other mobile computing system. Then the consumer clicks, or otherwise activates, a marketing device/coupon offering the first brand of HD TV for $250.00 at the first electronics store. Then, the consumer performs a quick search on-line using the consumer's smart phone, or other mobile computing system, and finds that a second electronics store, perhaps a web-based business, sells the same first brand of TV for $200, with free shipping. The consumer decides this is the best deal and then starts walking out of the first electronics store. However, using the process for providing dynamically customized marketing devices using real-time consumer data discussed herein, this data related to the shopping activities of the consumer is collected and is analyzed and transformed into current shopping analytics data associated with the consumer indicating the consumer is contemplating the purchase of the HD TV and has found a better deal with the second electronics store. Based on this data, in this specific illustrative example, a marketing device is then generated that includes an offer for the HD TV at a price of $190.00. Then, in this specific illustrative example, the created/transformed marketing device is provided to the consumer through the consumer's mobile computing system, or other computing system.

As another specific example, assume a given consumer opens up a marketing device access application, such as a mobile coupon application, on the consumer's smart phone, or other mobile computing system. Then the consumer clicks, or otherwise activates, marketing device/coupon offering $10-off a first brand of HD TV. In addition, in this specific illustrative example, assume the consumer further realizes he would want an HD DVD player to go with any new TV purchase. Consequently, the consumer then clicks, or otherwise activates, a marketing device/coupon offering $10-off a first brand of HD DVD player. Using the process for providing dynamically customized marketing devices using real-time consumer data discussed herein, this data related to the shopping activities of the consumer is analyzed and transformed into current shopping analytics data associated with the consumer indicating the consumer is contemplating the purchase of both the HD TV and HD DVD player. Then, in this specific illustrative example, a marketing device is generated that includes an offer of a $30.00 discount if the consumer purchases both the HD TV and an HD DVD. Then, in this specific illustrative example, the created/transformed marketing device is provided to the consumer through the consumer's mobile computing system, or other computing system.

As another specific illustrative example, assume the consumer is trying to decide between a first brand HD TV and a second brand HD TV. Further assume the consumer opens up a marketing device access application, such as a mobile coupon application, on the consumer's smart phone, or other mobile computing system. Then the consumer clicks, or otherwise activates, a marketing device/coupon offering the first brand of HD TV for $250.00 and then the consumer clicks, or otherwise activates, a marketing device/coupon offering the second brand of HD TV for $200.00. Using the process for providing dynamically customized marketing devices using real-time consumer data discussed herein, this data related to the shopping activities of the consumer is collected and is analyzed and transformed into current shopping analytics data associated with the consumer indicating the consumer is deciding between the first and second brand HD TVs. In this specific example, a marketing device is generated that includes an offer of a $60.00 discount on the first brand HD TV, bringing the effective price of the first brand HD TV to $190.00, or ten dollars less than the price of the second brand HD TV. Then, in this specific illustrative example, the created/transformed marketing device is provided to the consumer through the consumer's mobile computing system, or other computing system.

While specific illustrative examples are discussed above, and herein, these examples are provided strictly for illustration and to exemplify the operation of specific illustrative embodiments. Consequently, other embodiments can take many different forms and the claims below should not be construed as limited to the embodiments set forth herein, shown in the FIG.s, and/or described below. Rather, these exemplary embodiments are provided to allow a complete disclosure that conveys the principles of the invention, as set forth in the claims, to those of skill in the art.

### Hardware System Architecture

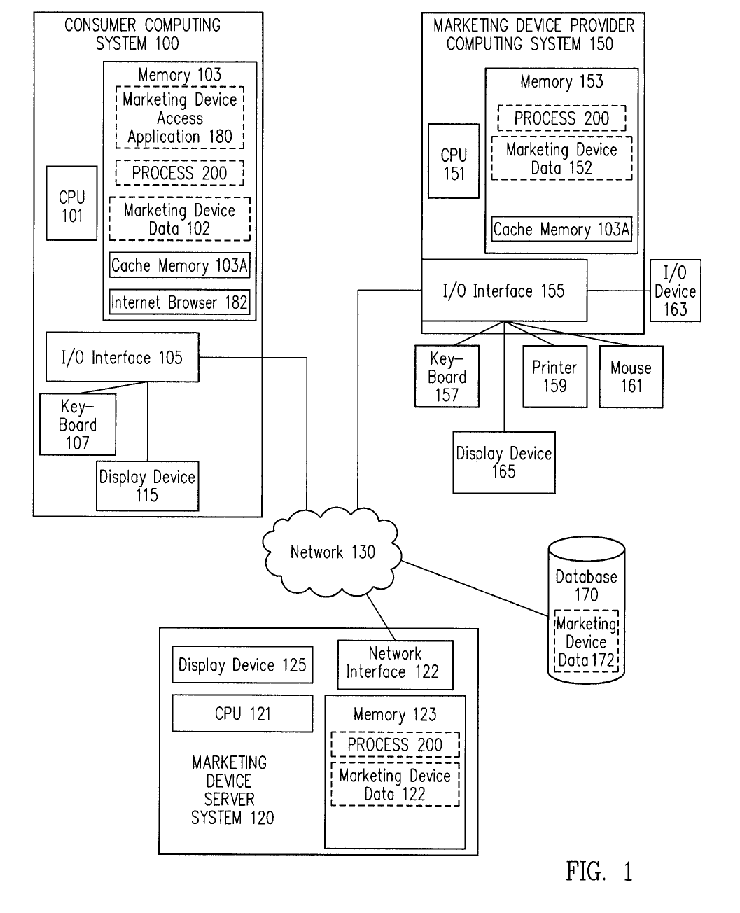

FIG. 1 is a block diagram of an exemplary hardware architecture for implementing one embodiment of a system and method for providing dynamically customized marketing devices using real-time consumer data, such as exemplary process 200 discussed herein, that includes: a consumer computing system 100, e.g., a first computing system, such as a mobile computing system or mobile phone; a marketing device provider computing system 150, e.g., a second computing system; a marketing device server system 120, e.g., a third computing system; and a database 170, all operatively coupled by a network 130.

As seen in FIG. 1, consumer computing system 100 typically includes a central processing unit (CPU) 101, an input/output (I/O) interface 105, and a memory system 103, including cache memory 103A. In one embodiment, memory system 103 includes all, or part of, a marketing device access application 180, such as a mobile coupon application. In one embodiment, marketing device access application 180 is any marketing device access application, and/or mobile coupon application, as discussed herein, and/or as known in the art at the time of filing, and/or as developed after the time of filing, implemented, at least in part, on consumer computing system 100.

In one embodiment, memory system 103 includes all, or part of, marketing device data 102 that represents one or more marketing devices, such as mobile coupons, that, in one embodiment, are accessed and/or downloaded to consumer computing system 100 using marketing device access application 180.

In one embodiment, marketing device access application 180 and/or marketing device data 102 is stored, in whole, or in part, in memory system 103, and is used by, or includes, as discussed below, a process for providing dynamically customized marketing devices using real-time consumer data, such as process 200 in FIG. 1.

Consumer computing system 100 may further include standard user interface devices such as a keyboard 107, a mouse, a printer, and a display device 115, as well as, one or more standard input/output (I/O) devices, such as a compact disk (CD) or Digital Video Disc (DVD) drive, floppy disk drive, or other digital or waveform port, or other device capable of inputting data to, and outputting data from, consumer computing system 100, whether available or known at the time of filing or as later developed. As discussed in more detail below, in one embodiment, a process for providing dynamically customized marketing devices using real-time consumer data and/or marketing device data are entered, in whole, or in part, into consumer computing system 100 via I/O device, such as from a CD, DVD, floppy disk, portable hard drive, memory stick, download site, or other medium and/or computer program product as defined herein.

In one embodiment, consumer computing system 100 also includes an Internet browser capability 182 that, in one embodiment, is stored, in whole, or in part in memory 103.

In one embodiment, consumer computing system 100 is a mobile computing system such as, but not limited to any one of: a cellular telephone; a smart phone; a digital wireless telephone; a Personal Digital Assistant (PDA); and/or any other device, or any desired combination of these devices, that includes components that can execute all, or part, of a process for providing dynamically customized marketing devices using real-time consumer data, as discussed herein, and/or as known in the art at the time of filing, and/or as developed after the time of filing.

As also shown in FIG. 1, marketing device provider computing system 150 typically includes a CPU 151, an input/output (I/O) interface 155, and a memory system 153, including cache memory 153A. Marketing device provider computing system 150 may further include standard user interface devices such as a keyboard 157, a mouse 161, a printer 159, and a display device 165, as well as, one or more standard input/output (I/O) devices 163, such as a compact disk (CD) or DVD drive, floppy disk drive, or other digital or waveform port, or other device capable of inputting data to, and outputting data from, marketing device provider computing system 150, whether available or known at the time of filing or as later developed.

In one embodiment, marketing device provider computing system 150 is accessible by a marketing device provider and, in one embodiment, memory system 153 includes all, or part of marketing device data 152 that represents one or more marketing devices, such as mobile coupons, that, in one embodiment, are accessed and/or downloaded to consumer computing system 100 using marketing device access application 180.

As discussed in more detail below, in one embodiment, all, or part of, a process for providing dynamically customized marketing devices using real-time consumer data can also be loaded, in whole, or in part, into marketing device provider computing system 150 from consumer computing system 100 for storage in memory system 153 and/or cache memory 153A.

Also seen in FIG. 1 is marketing device server system 120 that typically includes a central processing unit (CPU) 121, a network interface 122, and a memory system 123. In one embodiment, memory system 123 includes all, or part of, a process for providing dynamically customized marketing devices using real-time consumer data, such as process 200 in FIG. 1.

Marketing device server system 120 may further include a display device 125. As discussed in more detail below, in one embodiment, a process for providing dynamically customized marketing devices using real-time consumer data and/or a computing system implemented financial management system are entered, in whole, or in part, into marketing device server system 120 via an I/O device, such as from a CD, DVD, floppy disk, portable hard drive, memory stick, download site, or other medium and/or computer program product as defined herein.

In one embodiment, marketing device server system 120 is accessible by a marketing device provider and, in one embodiment, memory system 123 includes all, or part of marketing device data 122 that represents one or more marketing devices, such as mobile coupons, that, in one embodiment, are accessed and/or downloaded to consumer computing system 100 using marketing device access application 180.

In one embodiment, marketing device server system 120 is a computing system accessible by a consumer and/or a marketing device provider and is used and/or accessible by another computing system, such as consumer computing system 100 and/or marketing device provider computing system 150. In one embodiment, marketing device server system 120 is a workstation, a two-way pager, a cellular telephone, a smart phone, a digital wireless telephone, a Personal Digital Assistant (PDA), a server computer, an Internet appliance, any other device, or any desired combination of these devices, that includes components that can execute all, or part, of a process for providing dynamically customized marketing devices using real-time consumer data, and/or a marketing device data, in accordance with at least one of the embodiments as described herein.

Also shown in FIG. 1 is exemplary database 170. In one embodiment, database 170 is a data storage device, a designated server system or computing system, or a designated portion of one or more server systems or computing systems, such as computing systems 100, 150 and 120, or a distributed database, or an external and/or portable hard drive. In one embodiment, database 170 is a dedicated mass storage device implemented in software, hardware, or a combination of hardware and software. In one embodiment, database 170 is a web-based function. As discussed in more detail below, in one embodiment, database 170 is under the control of the consumer, and/or the consumer's agents, and/or a process for providing dynamically customized marketing devices using real-time consumer data, such as exemplary process 200, and/or a marketing device provider.

In one embodiment, database 170 is used, controlled, and/or accessible by, a provider of and/or a system and process for providing dynamically customized marketing devices using real-time consumer data, such as process for providing dynamically customized marketing devices using real-time consumer data 200 and includes all, or part of marketing device data 172 that represents one or more marketing devices, such as mobile coupons, that, in one embodiment, are accessed and/or downloaded to consumer computing system 100 using marketing device access application 180.

In one embodiment, computing systems 100, 120, and 150, and database 170, are coupled through network 130. Network 130 can be any network or network system that is of interest to a user such as, a peer-to-peer network, a hybrid peer-to-peer network, a Local Area Network (LAN), a Wide Area Network (WAN), a public network, such as the Internet, a private network, a combination of different network types, or other wireless, wired, and/or a wireless and wired combination network capable of allowing communication between two or more computing systems, whether available or known at the time of filing or as later developed.

In various embodiments, any one or more of consumer computing system 100, marketing device provider computing system 150, marketing device server system 120, and/or database 170 are part of a cloud computing environment.

Those of skill in the art will readily recognize that the components shown in FIG. 1, such as consumer computing system 100, marketing device provider computing system 150, marketing device server system 120, and/or database 170 and their respective components, are shown for illustrative purposes only and that architectures with more or fewer components can implement, and benefit from, the invention. Moreover, one or more components of consumer computing system 100, marketing device provider computing system 150, marketing device server system 120, and/or database 170 may be located remotely from their respective system and accessed via network, as discussed herein. In addition, the particular type of, and configuration of, consumer computing system 100, marketing device provider computing system 150, marketing device server system 120, and/or database 170 are not relevant.

As discussed in more detail below, in one embodiment, a process for providing dynamically customized marketing devices using real-time consumer data, such as process for providing dynamically customized marketing devices using real-time consumer data 200, and/or marketing device data, and/or a marketing device access application, such as marketing device access application 180, are stored, in whole, or in part, in memory system 103 and/or cache memory 103A, of consumer computing system 100, and/or memory system 153 and/or cache memory 153A of marketing device provider computing system 150, and/or in memory system 123, and/or in database 170, and executed on consumer computing system 100, and/or marketing device provider computing system 150, and/or marketing device server system 120. As used herein, a memory refers to a volatile memory, a non-volatile memory, or any combination of the two.

Although a process for providing dynamically customized marketing devices using real-time consumer data, such as process for providing dynamically customized marketing devices using real-time consumer data 200 and/or a marketing device access application, such as marketing device access application 180, are sometimes referred to herein, alternatively, as a process, an application, a module, a program, a component of a software system, a component of a software package, a component of a parent system, a plug-in, or a feature of a parent system, this terminology is illustrative only. In some embodiments, a process for providing dynamically customized marketing devices using real-time consumer data, such as process for providing dynamically customized marketing devices using real-time consumer data 200, and/or marketing device data, and/or a marketing device access application, such as marketing device access application 180, are capable of being called from an application or the operating system. In one embodiment, an application, process, or program is generally defined to be any executable code. Moreover, those of skill in the art will understand that when it is said that an application, process, or an operation takes some action, the action is the result of executing one or more instructions by a processor, such as CPUs 101, 121 and 151. In one embodiment, execution of a process by CPU 101, CPU 121, CPU 151, results in the operations of an agent computer process (not shown) and/or a rule computer process (not shown).

In one embodiment, a process for providing dynamically customized marketing devices using real-time consumer data, such as process for providing dynamically customized marketing devices using real-time consumer data 200, and/or marketing device data, and/or a marketing device access application, such as marketing device access application 180, are computer applications or processes and/or data implemented and/or run and/or stored, in full, or in part, in, or on, a computer program product. Herein, a computer program product comprises a medium and/or I/O device configured to store or transport computer readable code, whether available or known at the time of filing or as later developed. Some examples of computer program products are CDs, DVDs, ROM cards, floppy discs, magnetic tapes, computer hard drives, portable hard drives, flash memory, volatile and non-volatile memory sticks, servers on a network, such as marketing device server system 120 of FIG. 1, or other media or process capable of delivering computer readable data representing computer readable code, whether available or known at the time of filing or as later developed. This medium may belong to a computing system. However, in some embodiments, the medium also may be removable and/or remote from the computing system.

For example, all, or part, of a process for providing dynamically customized marketing devices using real-time consumer data, such as process for providing dynamically customized marketing devices using real-time consumer data 200, and/or marketing device data, and/or a marketing device access application, such as marketing device access application 180, may be stored in a memory that is physically located in a location, different from a computing system, such as computing systems 100, 120, and/or 150 of FIG. 1, utilizing a process for providing dynamically customized marketing devices using real-time consumer data, such as process for providing dynamically customized marketing devices using real-time consumer data 200, and/or marketing device data, and/or a marketing device access application, such as marketing device access application 180. In one embodiment, all, or part, of a process for providing dynamically customized marketing devices using real-time consumer data, such as process for providing dynamically customized marketing devices using real-time consumer data 200, and/or marketing device data, and/or a marketing device access application, such as marketing device access application 180, may be stored in a memory that is physically located, separate from the computing system's processor(s), such as CPUs 101, 121, and 151 of FIG. 1, and the computing system CPUs can be coupled to the memory in a client-server system, such as marketing device server system 120 of FIG. 1, or, alternatively, via connection to another computer, such as computing systems 100, 150 of FIG. 1, via modems and analog lines, digital interfaces and a digital carrier line, or wireless or cellular connections.

In one embodiment, the computing systems and/or server systems, such as computing systems 100, 120 and/or 150 of FIG. 1, running and/or utilizing and/or storing all, or part, of a process for providing dynamically customized marketing devices using real-time consumer data, such as process for providing dynamically customized marketing devices using real-time consumer data 200, and/or marketing device data, and/or a marketing device access application, such as marketing device access application 180, is a portable/mobile computer, a workstation, a two-way pager, a cellular telephone, a smart phone, a digital wireless telephone, a PDA, a server computer, an Internet appliance, or any other device that includes components that can execute all, or part, of a process for providing dynamically customized marketing devices using real-time consumer data, and/or marketing device data, in accordance with at least one of the embodiments as described herein. Similarly, in another embodiment, a process for providing dynamically customized marketing devices using real-time consumer data, such as process for providing dynamically customized marketing devices using real-time consumer data 200, and/or marketing device data, and/or a marketing device access application, such as marketing device access application 180, may be implemented on, and/or run, and/or stored on, a computing system and/or server system that is comprised of multiple different computers, wireless devices, cellular telephones, digital telephones, two-way pagers, personal digital assistants, server computers, or any desired combination of these devices, that are coupled to perform the processes and/or operations as described herein.

### Process

Herein, the terms “consumer”, “individual”, “user”, and/or “customer” are used interchangeably to denote any party interfacing and/or interacting with a process for providing dynamically customized marketing devices using real-time consumer data, and/or a person who is the subject of, and/or target of, all, or part of, any data/information obtained by a process for providing dynamically customized marketing devices using real-time consumer data, and/or a legal guardian of a person who is the subject of, and/or target of, any data/information obtained by a process for providing dynamically customized marketing devices using real-time consumer data, and/or an authorized agent of any party interfacing and/or interacting with a process for providing dynamically customized marketing devices using real-time consumer data, and/or a person who is the subject of, and/or target of, any information obtained by a process for providing dynamically customized marketing devices using real-time consumer data, and/or any other authorized party associated with any party interfacing and/or interacting with a process for providing dynamically customized marketing devices using real-time consumer data, and/or a person who is the subject of, and/or target of, any information obtained by a process for providing dynamically customized marketing devices using real-time consumer data.

Herein, the term “marketing device” includes traditional and/or electronic coupons, mobile coupons, virtual coupons offered as screen displays on computing systems, promotional certificates, promotional vouchers, sales offers, advertisements, and/or any other marketing tool and/or device, distributed by any distribution means, as discussed herein, and/or as known in the art at the time of filing, and/or as developed after the time of filing.

Herein, the term “mobile coupon” includes a marketing device is made available to, and/or delivered to, a consumer via a display device on one or more mobile computing systems, or other mobile devices.

Herein, the term “marketing device provider” includes, but is not limited to any one or more of: a “brick and mortar” merchant; and on-line merchant; a provider of products and/or services; a producer of products; an advertising agency and/or other party; or any other party, person, or entity desiring to distribute coupons and/or promotional offers.

As used herein, the term “mobile computing system” includes any computing system that is designed to be mobile such as, but not limited to: a cellular telephone; a smart phone; a digital wireless telephone; a Personal Digital Assistant (PDA); a media player, i.e., an MP3 player and/or other music and/or video player; an Internet appliance, or any other device that includes components that can execute all, or part, of any one of the processes and/or operations as described herein and that is generally able to be a mobile device.

As used herein, the term “computing system”, includes, but is not limited to: a desktop computer; a portable computer; a workstation; a two-way pager; a cellular telephone; a smart phone; a digital wireless telephone; a Personal Digital Assistant (PDA); a media player, i.e., an MP3 player and/or other music and/or video player; a server computer; an Internet appliance; or any other device that includes components that can execute all, or part, of any one of the processes and/or operations as described herein. In addition, as used herein, the term computing system, can denote, but is not limited to, computing systems made up of multiple: computers; wireless devices; cellular telephones; digital telephones; two-way pagers; PDAs; media players; server computers; or any desired combination of these devices, that are coupled to perform the processes and/or operations as described herein.

As used herein, the term “network” includes, but is not limited to, any network or network system such as, but not limited to, a peer-to-peer network, a hybrid peer-to-peer network, a Local Area Network (LAN), a Wide Area Network (WAN), a public network, such as the Internet, a private network, a cellular network, a combination of different network types, or other wireless, wired, and/or a wireless and wired combination network capable of allowing communication between two or more computing systems, whether available or known at the time of filing or as later developed.

As used herein, the term “database” includes, but is not limited to, any data storage mechanism known at the time of filing or as developed thereafter, such as, but not limited to: a data storage device; a designated server system or computing system, or a designated portion of one or more server systems or computing systems; a mobile computing system; a server system network; a distributed database; or an external and/or portable hard drive. Herein, the term “database” can refer to a dedicated mass storage device implemented in software, hardware, or a combination of hardware and software. Herein, the term “database” can refer to a web-based function. Herein, the term “database” can refer to any data storage means that is part of, or under the control of, any computing system, as discussed herein, known at the time of filing, or as developed thereafter.

In accordance with one embodiment, a method and system for providing dynamically customized marketing devices using real-time consumer data includes a process for providing dynamically customized marketing devices using real-time consumer data whereby, in one embodiment, shopping analytics data associated with a consumer regarding a consumer's current purchase related activity, such as, but not limited to, marketing offer searches recently made by the consumer, marketing offers recently viewed by the consumer, recent marketing offer downloads made by the consumer, recent marketing offer redemptions made by the consumer, network searches recently conducted by the consumer, and/or current GPS/location data for the consumer, is monitored and/or collected. In one embodiment, the shopping analytics data associated with the consumer is then used to automatically modify, and/or create, the terms of a mobile coupon, or other marketing device, and present the transformed mobile coupon, or other marketing device, to the consumer, in relative real-time, and in response to changing circumstances indicated by the shopping analytics data associated with the consumer.

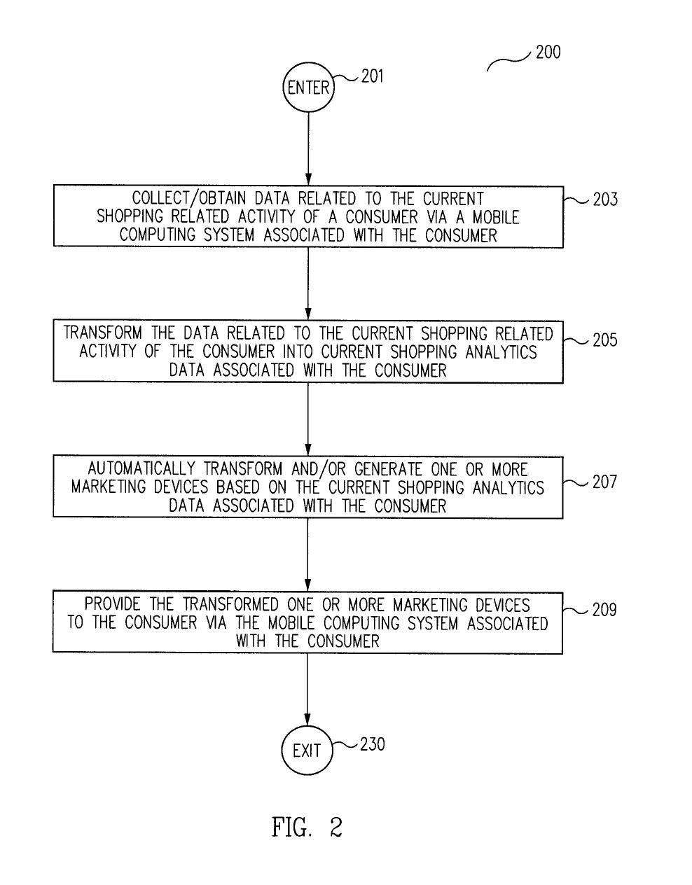

FIG. 2 a flow chart depicting a process for providing dynamically customized marketing devices using real-time consumer data 200 in accordance with one embodiment. Process for providing dynamically customized marketing devices using real-time consumer data 200 begins at ENTER OPERATION 201 of FIG. 2 and process flow proceeds to COLLECT/OBTAIN DATA RELATED TO THE CURRENT SHOPPING RELATED ACTIVITY OF A CONSUMER VIA A MOBILE COMPUTING SYSTEM ASSOCIATED WITH THE CONSUMER OPERATION 203.

In one embodiment, at COLLECT/OBTAIN DATA RELATED TO THE CURRENT SHOPPING RELATED ACTIVITY OF A CONSUMER VIA A MOBILE COMPUTING SYSTEM ASSOCIATED WITH THE CONSUMER OPERATION 203 data related to the shopping activities of a given consumer is collected, and/or monitored via the consumer's interactions with a mobile computing system, or other computing system, associated with the given consumer.

In one embodiment, at COLLECT/OBTAIN DATA RELATED TO THE CURRENT SHOPPING RELATED ACTIVITY OF A CONSUMER VIA A MOBILE COMPUTING SYSTEM ASSOCIATED WITH THE CONSUMER OPERATION 203 data related to the shopping activities of a given consumer is collected, and/or monitored, via the consumer's interactions with a mobile computing system, or other computing system, associated with the given consumer, such as consumer computing system 100 of FIG. 1.

Returning to FIG. 2, in one embodiment, the data related to the shopping activities of a given consumer collected at COLLECT/OBTAIN DATA RELATED TO THE CURRENT SHOPPING RELATED ACTIVITY OF A CONSUMER VIA A MOBILE COMPUTING SYSTEM ASSOCIATED WITH THE CONSUMER OPERATION 203 includes, but is not limited to, one or more of the following: the data related to the shopping activities of a given consumer collected includes, but is not limited to, one or more of the following: data indicating the marketing device/offer searches the consumer has recently conducted, and/or is conducting, using the mobile computing system, or other computing system, associated with the consumer; data indicating the marketing devices/offers the consumer has recently accessed, viewed, and/or downloaded, and/or is currently accessing, viewing, and/or downloading using the mobile computing system, or other computing system, associated with the consumer; data indicating recent marketing device/offer redemptions made by the consumer, and/or redemptions currently being made by the consumer, using the mobile computing system, or other computing system, associated with the consumer; data indicating network and/or website searches recently conducted by, or being conducted by, the consumer using the mobile computing system, or other computing system, associated with the consumer; data indicating historical purchase behavior/events associated with the consumer involving the current merchant and/or product or other merchants and/or products; data indicating various financial data associated with the consumer, such as, but not limited to, income, historical spending in various categories; data indicating a date and/or time of day; camera and/or other video data currently, or recently, recorded by the consumer using the mobile computing system, or other computing system, associated with the consumer, including but not limed to barcode data and/or image recognition data; data indicating the consumers distance from alternative merchants and/or products; and/or current GPS/location data for the consumer obtained from, or provided to, the mobile computing system, or other computing system, associated with the consumer.

In one embodiment, at COLLECT/OBTAIN DATA RELATED TO THE CURRENT SHOPPING RELATED ACTIVITY OF A CONSUMER VIA A MOBILE COMPUTING SYSTEM ASSOCIATED WITH THE CONSUMER OPERATION 203 data related to the shopping activities of a given consumer is collected, obtained, and/or monitored using one or more processors, such as CPUs 101, 151, and/or 121 of FIG. 1, associated with one or more computing systems, such as consumer computing system 100, marketing device provider computing system 150, and/or marketing device server system 120 of FIG. 1.

Returning to FIG. 2, in one embodiment, at COLLECT/OBTAIN DATA RELATED TO THE CURRENT SHOPPING RELATED ACTIVITY OF A CONSUMER VIA A MOBILE COMPUTING SYSTEM ASSOCIATED WITH THE CONSUMER OPERATION 203 data related to the shopping activities of a given consumer is collected, obtained, and/or monitored via a network of one or more computing systems, such as network 130 of FIG. 1.

Returning to FIG. 2, in one embodiment, once data related to the shopping activities of a given consumer is collected, and/or monitored via the consumer's interactions with a mobile computing system, or other computing system, associated with the given consumer at COLLECT/OBTAIN DATA RELATED TO THE CURRENT SHOPPING RELATED ACTIVITY OF A CONSUMER VIA A MOBILE COMPUTING SYSTEM ASSOCIATED WITH THE CONSUMER OPERATION 203, process flow proceeds to TRANSFORM THE DATA RELATED TO THE CURRENT SHOPPING RELATED ACTIVITY OT THE CONSUMER INTO CURRENT SHOPPING ANALYTICS DATA ASSOCIATED WITH THE CONSUMER OPERATION 205.

In one embodiment, at TRANSFORM THE DATA RELATED TO THE CURRENT SHOPPING RELATED ACTIVITY OT THE CONSUMER INTO CURRENT SHOPPING ANALYTICS DATA ASSOCIATED WITH THE CONSUMER OPERATION 205 the collected/obtained data related to the shopping activities of the given consumer of COLLECT/OBTAIN DATA RELATED TO THE CURRENT SHOPPING RELATED ACTIVITY OF A CONSUMER VIA A MOBILE COMPUTING SYSTEM ASSOCIATED WITH THE CONSUMER OPERATION 203 is analyzed to transform the raw data into current shopping analytics data associated with the consumer regarding the consumer's current purchase related activity.

In one embodiment, at TRANSFORM THE DATA RELATED TO THE CURRENT SHOPPING RELATED ACTIVITY OT THE CONSUMER INTO CURRENT SHOPPING ANALYTICS DATA ASSOCIATED WITH THE CONSUMER OPERATION 205 the collected/obtained data related to the shopping activities of the given consumer of COLLECT/OBTAIN DATA RELATED TO THE CURRENT SHOPPING RELATED ACTIVITY OF A CONSUMER VIA A MOBILE COMPUTING SYSTEM ASSOCIATED WITH THE CONSUMER OPERATION 203 is analyzed to transform the raw data into current shopping analytics data associated with the consumer regarding the consumer's current purchase related activity, such as, but not limited to: what types of products the consumer is currently considering purchasing; products related to the types of products the consumer is currently considering purchasing; what marketing devices and/or offers are currently being offered to, and/or considered by, the consumer; the terms of the marketing devices and/or offers currently being offered to, and/or considered by, the consumer; the physical location of the consumer; how close the consumer is to actually making a purchase decision; how carefully the consumer is considering a given purchase and how interested the consumer is in a given product or service.

In one embodiment, at TRANSFORM THE DATA RELATED TO THE CURRENT SHOPPING RELATED ACTIVITY OT THE CONSUMER INTO CURRENT SHOPPING ANALYTICS DATA ASSOCIATED WITH THE CONSUMER OPERATION 205 the collected/obtained data related to the shopping activities of the given consumer of COLLECT/OBTAIN DATA RELATED TO THE CURRENT SHOPPING RELATED ACTIVITY OF A CONSUMER VIA A MOBILE COMPUTING SYSTEM ASSOCIATED WITH THE CONSUMER OPERATION 203 is analyzed to transform the raw data into current shopping analytics data associated with the consumer regarding the consumer's current purchase related activity using one or more processors, such as CPUs 101, 151, and/or 121 of FIG. 1, associated with one or more computing systems, such as consumer computing system 100, marketing device provider computing system 150, and/or marketing device server system 120 of FIG. 1.

Returning to FIG. 2, in one embodiment, once the collected/obtained data related to the shopping activities of the given consumer of COLLECT/OBTAIN DATA RELATED TO THE CURRENT SHOPPING RELATED ACTIVITY OF A CONSUMER VIA A MOBILE COMPUTING SYSTEM ASSOCIATED WITH THE CONSUMER OPERATION 203 is analyzed to transform the raw data into current shopping analytics data associated with the consumer regarding the consumer's current purchase related activity at TRANSFORM THE DATA RELATED TO THE CURRENT SHOPPING RELATED ACTIVITY OT THE CONSUMER INTO CURRENT SHOPPING ANALYTICS DATA ASSOCIATED WITH THE CONSUMER OPERATION 205, process flow proceeds to AUTOMATICALLY TRANSFORM AND/OR GENERATE ONE OR MORE MARKETING DEVICES BASED ON THE CURRENT SHOPPING ANALYTICS DATA ASSOCIATED WITH THE CONSUMER OPERATION 207.

In one embodiment, at AUTOMATICALLY TRANSFORM AND/OR GENERATE ONE OR MORE MARKETING DEVICES BASED ON THE CURRENT SHOPPING ANALYTICS DATA ASSOCIATED WITH THE CONSUMER OPERATION 207 the current shopping analytics data associated with the consumer of TRANSFORM THE DATA RELATED TO THE CURRENT SHOPPING RELATED ACTIVITY OT THE CONSUMER INTO CURRENT SHOPPING ANALYTICS DATA ASSOCIATED WITH THE CONSUMER OPERATION 205 is used to automatically transform, i.e., modify, and/or create, a mobile coupon, or other marketing device, and/or transform, define, or re-define, the terms of a mobile coupon, or other marketing device, in relative real-time with, and in response to, circumstances indicated by the current shopping analytics data associated with the consumer of TRANSFORM THE DATA RELATED TO THE CURRENT SHOPPING RELATED ACTIVITY OT THE CONSUMER INTO CURRENT SHOPPING ANALYTICS DATA ASSOCIATED WITH THE CONSUMER OPERATION 205.

In one embodiment, at AUTOMATICALLY TRANSFORM AND/OR GENERATE ONE OR MORE MARKETING DEVICES BASED ON THE CURRENT SHOPPING ANALYTICS DATA ASSOCIATED WITH THE CONSUMER OPERATION 207 the current shopping analytics data associated with the consumer of TRANSFORM THE DATA RELATED TO THE CURRENT SHOPPING RELATED ACTIVITY OT THE CONSUMER INTO CURRENT SHOPPING ANALYTICS DATA ASSOCIATED WITH THE CONSUMER OPERATION 205 is used by one or more processors, such as CPUs 101, 151, and/or 121 of FIG. 1, associated with one or more computing systems, such as consumer computing system 100, marketing device provider computing system 150, and/or marketing device server system 120 of FIG. 1 to automatically transform, i.e., modify, and/or create, a mobile coupon, or other marketing device, and/or transform, define, or re-define, the terms of a mobile coupon, or other marketing device, in relative real-time with, and in response to, circumstances indicated by the current shopping analytics data associated with the consumer of TRANSFORM THE DATA RELATED TO THE CURRENT SHOPPING RELATED ACTIVITY OT THE CONSUMER INTO CURRENT SHOPPING ANALYTICS DATA ASSOCIATED WITH THE CONSUMER OPERATION 205.

Returning to FIG. 2, once the current shopping analytics data associated with the consumer of TRANSFORM THE DATA RELATED TO THE CURRENT SHOPPING RELATED ACTIVITY OT THE CONSUMER INTO CURRENT SHOPPING ANALYTICS DATA ASSOCIATED WITH THE CONSUMER OPERATION 205 is used to automatically transform, i.e., modify, and/or create, a mobile coupon, or other marketing device, and/or transform, define, or re-define, the terms of a mobile coupon, or other marketing device, in relative real-time with, and in response to, circumstances indicated by the current shopping analytics data associated with the consumer of TRANSFORM THE DATA RELATED TO THE CURRENT SHOPPING RELATED ACTIVITY OT THE CONSUMER INTO CURRENT SHOPPING ANALYTICS DATA ASSOCIATED WITH THE CONSUMER OPERATION 205 at AUTOMATICALLY TRANSFORM AND/OR GENERATE ONE OR MORE MARKETING DEVICES BASED ON THE CURRENT SHOPPING ANALYTICS DATA ASSOCIATED WITH THE CONSUMER OPERATION 207, process flow proceeds to PROVIDE THE TRANSFORMED ONE OR MORE MARKETING DEVICES TO THE CONSUMER VIA THE MOBILE COMPUTING SYSTEM ASSOCIATED WITH THE CONSUMER OPERATION 209.

In one embodiment, at PROVIDE THE TRANSFORMED ONE OR MORE MARKETING DEVICES TO THE CONSUMER VIA THE MOBILE COMPUTING SYSTEM ASSOCIATED WITH THE CONSUMER OPERATION 209, the transformed mobile coupon, or other marketing device, of AUTOMATICALLY TRANSFORM AND/OR GENERATE ONE OR MORE MARKETING DEVICES BASED ON THE CURRENT SHOPPING ANALYTICS DATA ASSOCIATED WITH THE CONSUMER OPERATION 207 is provided to the consumer, in one embodiment, through the mobile computing system, or other computing system, associated with the given consumer of COLLECT/OBTAIN DATA RELATED TO THE CURRENT SHOPPING RELATED ACTIVITY OF A CONSUMER VIA A MOBILE COMPUTING SYSTEM ASSOCIATED WITH THE CONSUMER OPERATION 203.

In one embodiment, at PROVIDE THE TRANSFORMED ONE OR MORE MARKETING DEVICES TO THE CONSUMER VIA THE MOBILE COMPUTING SYSTEM ASSOCIATED WITH THE CONSUMER OPERATION 209 the transformed mobile coupon, or other marketing device, is provided to the consumer via one or more processors, such as CPUs 101, 151, and/or 121 of FIG. 1, associated with one or more computing systems, such as consumer computing system 100, marketing device provider computing system 150, and/or marketing device server system 120 of FIG. 1.

Returning to FIG. 2, in one embodiment, at PROVIDE THE TRANSFORMED ONE OR MORE MARKETING DEVICES TO THE CONSUMER VIA THE MOBILE COMPUTING SYSTEM ASSOCIATED WITH THE CONSUMER OPERATION 209 the transformed mobile coupon, or other marketing device, is provided to the consumer via a network of one or more computing systems, such as network 130 of FIG. 1.

Returning to FIG. 2, in one embodiment, at PROVIDE THE TRANSFORMED ONE OR MORE MARKETING DEVICES TO THE CONSUMER VIA THE MOBILE COMPUTING SYSTEM ASSOCIATED WITH THE CONSUMER OPERATION 209 the transformed mobile coupon, or other marketing device, is provided to the consumer via a database, such as database 170 of FIG. 1, a website, or web-based system.

Returning to FIG. 2, in various embodiments, at PROVIDE THE TRANSFORMED ONE OR MORE MARKETING DEVICES TO THE CONSUMER VIA THE MOBILE COMPUTING SYSTEM ASSOCIATED WITH THE CONSUMER OPERATION 209 the transformed mobile coupon, or other marketing device, is provided to the consumer using any method, means, process, and/or procedure for transferring data, as discussed herein, and/or as known in the art at the time of filing, and/or as developed after the time of filing.

Referring to FIGS. 1 and 2 together, as one illustrative example of the operation of one specific embodiment of process for providing dynamically customized marketing devices using real-time consumer data 200, assume a given consumer opens up a marketing device access application, such as marketing device access application 180 of FIG. 1, or any mobile coupon application, on the consumer's smart phone, or other mobile computing system, such as consumer computing system 100. Further assume the consumer then clicks, or otherwise activates, a marketing device/coupon from, in one embodiment, marketing device data 102, offering $10-off a first brand of HD TV.

Using process for providing dynamically customized marketing devices using real-time consumer data 200, at COLLECT/OBTAIN DATA RELATED TO THE CURRENT SHOPPING RELATED ACTIVITY OF A CONSUMER VIA A MOBILE COMPUTING SYSTEM ASSOCIATED WITH THE CONSUMER OPERATION 203 this data related to the shopping activities of the consumer, i.e., data indicating the marketing devices/offers the consumer has recently accessed, viewed, and/or downloaded, and/or is currently accessing, viewing, and/or downloading using the mobile computing system, or other computing system, is collected and at TRANSFORM THE DATA RELATED TO THE CURRENT SHOPPING RELATED ACTIVITY OT THE CONSUMER INTO CURRENT SHOPPING ANALYTICS DATA ASSOCIATED WITH THE CONSUMER OPERATION 205 is analyzed and transformed into current shopping analytics data associated with the consumer indicating the consumer is contemplating the purchase of the HD TV. Then, in this specific illustrative example, a marketing device is generated at AUTOMATICALLY TRANSFORM AND/OR GENERATE ONE OR MORE MARKETING DEVICES BASED ON THE CURRENT SHOPPING ANALYTICS DATA ASSOCIATED WITH THE CONSUMER OPERATION 207 that includes an offer of a $20.00 discount if the consumer purchases both the HD TV and an HD DVD. Then, in this specific illustrative example, the created/transformed marketing device is provided to the consumer through the consumer's mobile computing system, or other computing system, at PROVIDE THE TRANSFORMED ONE OR MORE MARKETING DEVICES TO THE CONSUMER VIA THE MOBILE COMPUTING SYSTEM ASSOCIATED WITH THE CONSUMER OPERATION 209.

Referring to FIGS. 1 and 2 together, as another illustrative example of the operation of one specific embodiment of process for providing dynamically customized marketing devices using real-time consumer data 200, assume a given consumer is in a first electronics store and sees a first brand HD TV for sale for $300.00. Further assume the given consumer opens up a marketing device access application, such as marketing device access application 180 of FIG. 1, or any mobile coupon application, on the consumer's smart phone, or other mobile computing system, such as consumer computing system 100. Further assume the consumer then clicks, or otherwise activates, a marketing device/coupon, in one embodiment, from marketing device data 102, offering the first brand of HD TV for $250.00 at the first electronics store. Then, the consumer performs a quick search on-line using the consumer's smart phone, or other mobile computing system, and finds that a second electronics store, perhaps a web-based business, sells the same first brand of TV for $200, with free shipping. The consumer decides this is the best deal and then starts walking out of the first electronics store, in one embodiment, as indicated by GPS data.

However, using process for providing dynamically customized marketing devices using real-time consumer data 200, this data related to the shopping activities of the consumer is collected at COLLECT/OBTAIN DATA RELATED TO THE CURRENT SHOPPING RELATED ACTIVITY OF A CONSUMER VIA A MOBILE COMPUTING SYSTEM ASSOCIATED WITH THE CONSUMER OPERATION 203 and is analyzed and transformed into current shopping analytics data associated with the consumer at TRANSFORM THE DATA RELATED TO THE CURRENT SHOPPING RELATED ACTIVITY OT THE CONSUMER INTO CURRENT SHOPPING ANALYTICS DATA ASSOCIATED WITH THE CONSUMER OPERATION 205 indicating the consumer is contemplating the purchase of the HD TV and has found a better deal with the second electronics store. Based on this data, in this specific illustrative example, a marketing device is then generated at AUTOMATICALLY TRANSFORM AND/OR GENERATE ONE OR MORE MARKETING DEVICES BASED ON THE CURRENT SHOPPING ANALYTICS DATA ASSOCIATED WITH THE CONSUMER OPERATION 207 that includes an offer for the HD TV at a price of $190.00. Then, in this specific illustrative example, the created/transformed marketing device is provided to the consumer through the consumer's mobile computing system, or other computing system, at PROVIDE THE TRANSFORMED ONE OR MORE MARKETING DEVICES TO THE CONSUMER VIA THE MOBILE COMPUTING SYSTEM ASSOCIATED WITH THE CONSUMER OPERATION 209.

Referring to FIGS. 1 and 2 together, as another illustrative example of the operation of one specific embodiment of process for providing dynamically customized marketing devices using real-time consumer data 200, assume the customer opens up a marketing device access application, such as marketing device access application 180 of FIG. 1, or any mobile coupon application, on the consumer's smart phone, or other mobile computing system, such as consumer computing system 100. Further assume the consumer then clicks, or otherwise activates, a marketing device/coupon from, in one embodiment, marketing device data 102, offering $10-off a first brand of HD TV. In addition, in this specific illustrative example, assume the consumer further realizes he would want an HD DVD player to go with any new TV purchase. Consequently, the consumer then clicks, or otherwise activates, a marketing device/coupon offering $10-off a first brand of HD DVD player.

Using process for providing dynamically customized marketing devices using real-time consumer data 200, this data related to the shopping activities of the consumer is collected at COLLECT/OBTAIN DATA RELATED TO THE CURRENT SHOPPING RELATED ACTIVITY OF A CONSUMER VIA A MOBILE COMPUTING SYSTEM ASSOCIATED WITH THE CONSUMER OPERATION 203 and is analyzed and transformed into current shopping analytics data associated with the consumer at TRANSFORM THE DATA RELATED TO THE CURRENT SHOPPING RELATED ACTIVITY OT THE CONSUMER INTO CURRENT SHOPPING ANALYTICS DATA ASSOCIATED WITH THE CONSUMER OPERATION 205 indicating the consumer is contemplating the purchase of both the HD TV and HD DVD player. Then, in this specific illustrative example, a marketing device is generated at AUTOMATICALLY TRANSFORM AND/OR GENERATE ONE OR MORE MARKETING DEVICES BASED ON THE CURRENT SHOPPING ANALYTICS DATA ASSOCIATED WITH THE CONSUMER OPERATION 207 that includes an offer of a $30.00 discount if the consumer purchases both the HD TV and an HD DVD. Then, in this specific illustrative example, the created/transformed marketing device is provided to the consumer through the consumer's mobile computing system, or other computing system, at PROVIDE THE TRANSFORMED ONE OR MORE MARKETING DEVICES TO THE CONSUMER VIA THE MOBILE COMPUTING SYSTEM ASSOCIATED WITH THE CONSUMER OPERATION 209.

Referring to FIGS. 1 and 2 together, as another illustrative example of the operation of one specific embodiment of process for providing dynamically customized marketing devices using real-time consumer data 200, assume the consumer is trying to decide between a first brand HD TV and a second brand HD TV. Further assume the customer opens up a marketing device access application, such as marketing device access application 180 of FIG. 1, or any mobile coupon application, on the consumer's smart phone, or other mobile computing system, such as consumer computing system 100. Further assume the consumer then clicks, or otherwise activates, a marketing device/coupon from, in one embodiment, marketing device data 102, offering the first brand of HD TV for $250.00 and then the consumer clicks, or otherwise activates, a marketing device/coupon offering the second brand of HD TV for $200.00.

Using process for providing dynamically customized marketing devices using real-time consumer data 200, this data related to the shopping activities of the consumer is collected at COLLECT/OBTAIN DATA RELATED TO THE CURRENT SHOPPING RELATED ACTIVITY OF A CONSUMER VIA A MOBILE COMPUTING SYSTEM ASSOCIATED WITH THE CONSUMER OPERATION 203 and is analyzed and transformed into current shopping analytics data associated with the consumer at TRANSFORM THE DATA RELATED TO THE CURRENT SHOPPING RELATED ACTIVITY OT THE CONSUMER INTO CURRENT SHOPPING ANALYTICS DATA ASSOCIATED WITH THE CONSUMER OPERATION 205 indicating the consumer is deciding between the first and second brand HD TVs. In this specific example, a marketing device is generated at AUTOMATICALLY TRANSFORM AND/OR GENERATE ONE OR MORE MARKETING DEVICES BASED ON THE CURRENT SHOPPING ANALYTICS DATA ASSOCIATED WITH THE CONSUMER OPERATION 207 that includes an offer of a $60.00 discount on the first brand HD TV; bringing the effective price of the first brand HD TV to $190.00, or ten dollars less than the price of the second brand HD TV. Then, in this specific illustrative example, the created/transformed marketing device is provided to the consumer through the consumer's mobile computing system, or other computing system at PROVIDE THE TRANSFORMED ONE OR MORE MARKETING DEVICES TO THE CONSUMER VIA THE MOBILE COMPUTING SYSTEM ASSOCIATED WITH THE CONSUMER OPERATION 209.

While specific illustrative examples are discussed herein, these examples are provided strictly for illustration and to exemplify the operation of specific illustrative embodiments. Consequently, other embodiments can take many different forms and the claims below should not be construed as limited to the embodiments set forth herein, shown in the FIG.s, and/or described below. Rather, these exemplary embodiments are provided to allow a complete disclosure that conveys the principles of the invention, as set forth in the claims, to those of skill in the art.

In one embodiment, once the transformed mobile coupon, or other marketing device, of AUTOMATICALLY TRANSFORM AND/OR GENERATE ONE OR MORE MARKETING DEVICES BASED ON THE CURRENT SHOPPING ANALYTICS DATA ASSOCIATED WITH THE CONSUMER OPERATION 207 is provided to the consumer, in one embodiment, through the mobile computing system, or other computing system, associated with the given consumer of COLLECT/OBTAIN DATA RELATED TO THE CURRENT SHOPPING RELATED ACTIVITY OF A CONSUMER VIA A MOBILE COMPUTING SYSTEM ASSOCIATED WITH THE CONSUMER OPERATION 203 at PROVIDE THE TRANSFORMED ONE OR MORE MARKETING DEVICES TO THE CONSUMER VIA THE MOBILE COMPUTING SYSTEM ASSOCIATED WITH THE CONSUMER OPERATION 209 process flow proceeds to EXIT OPERATION 230. In one embodiment, at EXIT OPERATION 230, process for providing dynamically customized marketing devices using real-time consumer data 200 is exited to await new data.

Using process for providing dynamically customized marketing devices using real-time consumer data 200, a consumer is provided mobile coupons, or other marketing devices, whose terms are dynamically changed, in real time, to more closely meet the identified needs of that consumer's present situation. Consequently, using process for providing dynamically customized marketing devices using real-time consumer data 200, marketing device providers can provide marketing devices that are more likely to address the needs of a given consumer and are more likely to be used by the given consumer.

As discussed in more detail above, using the above embodiments, with little or no modification and/or user input, there is considerable flexibility, adaptability, and opportunity for customization to meet the specific needs of various users under numerous circumstances.

In the discussion above, certain aspects of one embodiment include process steps and/or operations and/or instructions described herein for illustrative purposes in a particular order and/or grouping. However, the particular order and/or grouping shown and discussed herein are illustrative only and not limiting. Those of skill in the art will recognize that other orders and/or grouping of the process steps and/or operations and/or instructions are possible and, in some embodiments, one or more of the process steps and/or operations and/or instructions discussed above can be combined and/or deleted. In addition, portions of one or more of the process steps and/or operations and/or instructions can be re-grouped as portions of one or more other of the process steps and/or operations and/or instructions discussed herein. Consequently, the particular order and/or grouping of the process steps and/or operations and/or instructions discussed herein do not limit the scope of the invention as claimed below.

As discussed in more detail above, using the above embodiments, with little or no modification and/or user input, there is considerable flexibility, adaptability, and opportunity for customization to meet the specific needs of various users under numerous circumstances.

The present invention has been described in particular detail with respect to specific possible embodiments. Those of skill in the art will appreciate that the invention may be practiced in other embodiments. For example, the nomenclature used for components, capitalization of component designations and terms, the attributes, data structures, or any other programming or structural aspect is not significant, mandatory, or limiting, and the mechanisms that implement the invention or its features can have various different names, formats, or protocols. Further, the system or functionality of the invention may be implemented via various combinations of software and hardware, as described, or entirely in hardware elements. Also, particular divisions of functionality between the various components described herein are merely exemplary, and not mandatory or significant. Consequently, functions performed by a single component may, in other embodiments, be performed by multiple components, and functions performed by multiple components may, in other embodiments, be performed by a single component.

Some portions of the above description present the features of the present invention in terms of algorithms and symbolic representations of operations, or algorithm-like representations, of operations on information/data. These algorithmic or algorithm-like descriptions and representations are the means used by those of skill in the art to most effectively and efficiently convey the substance of their work to others of skill in the art. These operations, while described functionally or logically, are understood to be implemented by computer programs or computing systems. Furthermore, it has also proven convenient at times to refer to these arrangements of operations as steps or modules or by functional names, without loss of generality.

Unless specifically stated otherwise, as would be apparent from the above discussion, it is appreciated that throughout the above description, discussions utilizing terms such as “obtaining”, “collecting”, “transforming”, “verifying”, “monitoring”, “browsing”, “updating”, “associating”, “analyzing”, “defining”, “storing”, “saving”, “displaying”, “implementing”, “performing”, “creating”, “assigning”, “estimating”, “entering”, “modifying”, “categorizing”, “providing”, “processing”, “accessing”, “selecting”, “enrolling”, “using”, “submitting”, “generating”, etc., refer to the action and process of a computing system or similar electronic device that manipulates and operates on data represented as physical (electronic) quantities within the computing system memories, resisters, caches or other information storage, transmission or display devices.

Certain aspects of the present invention include process steps or operations and instructions described herein in an algorithmic or algorithmic-like form. It should be noted that the process steps or operations and instructions of the present invention can be embodied in software, firmware, or hardware, and when embodied in software, can be downloaded to reside on and be operated from different platforms used by real time network operating systems.

The present invention also relates to an apparatus or system for performing the operations described herein. This apparatus or system may be specifically constructed for the required purposes, or the apparatus or system can comprise a general purpose system selectively activated or configured/reconfigured by a computer program stored on a computer program product as discussed herein that can be accessed by a computing system or other device.

Those of skill in the art will readily recognize that the algorithms and operations presented herein are not inherently related to any particular computing system, computer architecture, computer or industry standard, or any other specific apparatus. Various general purpose systems may also be used with programs in accordance with the teaching herein, or it may prove more convenient/efficient to construct more specialized apparatuses to perform the required operations described herein. The required structure for a variety of these systems will be apparent to those of skill in the art, along with equivalent variations. In addition, the present invention is not described with reference to any particular programming language and it is appreciated that a variety of programming languages may be used to implement the teachings of the present invention as described herein, and any references to a specific language or languages are provided for illustrative purposes only and for enablement of the contemplated best mode of the invention at the time of filing.

The present invention is well suited to a wide variety of computer network systems operating over numerous topologies. Within this field, the configuration and management of large networks comprise storage devices and computers that are communicatively coupled to similar or dissimilar computers and storage devices over a private network, a LAN, a WAN, a private network, or a public network, such as the Internet.

It should also be noted that the language used in the specification has been principally selected for readability, clarity and instructional purposes, and may not have been selected to delineate or circumscribe the inventive subject matter. Accordingly, the disclosure of the present invention is intended to be illustrative, but not limiting, of the scope of the invention, which is set forth in the claims below.

In addition, the operations shown in the FIG.s, or as discussed herein, are identified using a particular nomenclature for ease of description and understanding, but other nomenclature is often used in the art to identify equivalent operations.

Therefore, numerous variations, whether explicitly provided for by the specification or implied by the specification or not, may be implemented by one of skill in the art in view of this disclosure.

What is claimed is:

1. A computing system implemented process for providing dynamically customized marketing devices using real-time consumer data comprising:
obtaining data related to the current shopping related activity of a consumer from a mobile computing system associated with the consumer and one or more of the consumer's interactions with the mobile computing system associated with the consumer;
using one or more processors associated with one or more computing systems to analyze and transform the data related to the current shopping related activity of a consumer into current shopping analytics data associated with the consumer indicating one or more current shopping circumstances associated with the consumer;
using one or more processors associated with one or more computing systems to automatically generate one or more marketing devices, the terms of the one or more marketing devices being based, at least in part, on the current shopping analytics data associated with the consumer indicating one or more current shopping circumstances associated with the consumer; and
providing data representing the one or more marketing devices to the consumer through the mobile computing system associated with the consumer.

2. The computing system implemented process for providing dynamically customized marketing devices using real-time consumer data of claim 1, wherein;
the mobile computing system associated with the consumer is a mobile telephone or smart phone.

3. The computing system implemented process for providing dynamically customized marketing devices using real-time consumer data of claim 1, wherein;
the data related to the current shopping related activity of a consumer obtained from a mobile computing system associated with the consumer and one or more of the consumer's interactions with the mobile computing system associated with the consumer includes one or more data selected from the group of data consisting of:
data indicating marketing device searches the consumer has recently conducted, and/or is conducting, using the mobile computing system associated with the consumer;
data indicating the marketing devices the consumer has recently accessed, viewed, and/or downloaded, and/or is currently accessing, viewing, and/or downloading using the mobile computing system associated with the consumer;
data indicating recent marketing device redemptions made by the consumer, and/or redemptions currently being made by the consumer, using the mobile computing system associated with the consumer;
data indicating network and/or website searches recently conducted by, or being conducted by, the consumer using the mobile computing system associated with the consumer;
data indicating historical purchase behavior/events associated with the consumer involving the current merchant and/or product or other merchants and/or products;
data indicating various financial data associated with the consumer;
data indicating a date and/or time of day;
camera and/or other video data currently, or recently, recorded by the consumer using the mobile computing system;
data indicating the consumers distance from alternative merchants and/or products; and
current GPS/location data for the consumer obtained from, or provided to, the mobile computing system associated with the consumer.

4. The computing system implemented process for providing dynamically customized marketing devices using real-time consumer data of claim 1, wherein;
the current shopping analytics data associated with the consumer indicating one or more current shopping circumstances associated with the consumer includes one or more current shopping analytics data associated with the consumer indicating one or more current shopping circumstances associated with the consumer selected from the group of current shopping analytics data associated with the consumer indicating one or more current shopping circumstances associated with the consumer consisting of:
data indicating what types of products the consumer is currently considering purchasing;
data indicating products related to the types of products the consumer is currently considering purchasing;
data indicating what marketing devices and/or offers are currently being offered to, and/or considered by, the consumer;
data indicating the terms of the marketing devices and/or offers currently being offered to, and/or considered by, the consumer;
data indicating the physical location of the consumer;
data indicating how close the consumer is to actually making a purchase decision; and
data indicating how carefully the consumer is considering a given purchase and how interested the consumer is in a given product or service.

5. The computing system implemented process for providing dynamically customized marketing devices using real-time consumer data of claim 1, wherein;
the automatically generated one or more marketing devices include a mobile coupon.

6. A computing system implemented process for providing dynamically customized marketing devices using real-time consumer data comprising:
obtaining data related to the current shopping related activity of a consumer from a mobile computing system associated with the consumer and one or more of the consumer's interactions with the mobile computing system associated with the consumer;
using one or more processors associated with one or more computing systems to analyze and transform the data related to the current shopping related activity of a consumer into current shopping analytics data associated with the consumer indicating one or more current shopping circumstances associated with the consumer;
using one or more processors associated with one or more computing systems to automatically transform one or more marketing devices based, at least in part, on the current shopping analytics data associated with the consumer indicating one or more current shopping circumstances associated with the consumer; and
providing data representing the one or more transformed marketing devices to the consumer through the mobile computing system associated with the consumer.

7. The computing system implemented process for providing dynamically customized marketing devices using real-time consumer data of claim 6, wherein;
the mobile computing system associated with the consumer is a mobile telephone or smart phone.

8. The computing system implemented process for providing dynamically customized marketing devices using real-time consumer data of claim 6, wherein;
the data related to the current shopping related activity of a consumer obtained from a mobile computing system associated with the consumer and one or more of the consumer's interactions with the mobile computing system associated with the consumer includes one or more data selected from the group of data consisting of:
data indicating marketing device searches the consumer has recently conducted, and/or is conducting, using the mobile computing system associated with the consumer;
data indicating the marketing devices the consumer has recently accessed, viewed, and/or downloaded, and/or is currently accessing, viewing, and/or downloading using the mobile computing system associated with the consumer;
data indicating recent marketing device redemptions made by the consumer, and/or redemptions currently being made by the consumer, using the mobile computing system associated with the consumer;
data indicating network and/or website searches recently conducted by, or being conducted by, the consumer using the mobile computing system associated with the consumer; data indicating historical purchase behavior/events associated with the consumer involving the current merchant and/or product or other merchants and/or products;
data indicating various financial data associated with the consumer;
data indicating a date and/or time of day;
camera and/or other video data currently, or recently, recorded by the consumer using the mobile computing system;
data indicating the consumers distance from alternative merchants and/or products; and
current GPS/location data for the consumer obtained from, or provided to, the mobile computing system associated with the consumer.

9. The computing system implemented process for providing dynamically customized marketing devices using real-time consumer data of claim 6, wherein;
the current shopping analytics data associated with the consumer indicating one or more current shopping circumstances associated with the consumer includes one or more current shopping analytics data associated with the consumer indicating one or more current shopping circumstances associated with the consumer selected from the group of current shopping analytics data associated with the consumer indicating one or more current shopping circumstances associated with the consumer consisting of:
data indicating what types of products the consumer is currently considering purchasing;
data indicating products related to the types of products the consumer is currently considering purchasing;
data indicating what marketing devices and/or offers are currently being offered to, and/or considered by, the consumer;
data indicating the terms of the marketing devices and/or offers currently being offered to, and/or considered by, the consumer;
data indicating the physical location of the consumer;
data indicating how close the consumer is to actually making a purchase decision; and
data indicating how carefully the consumer is considering a given purchase and how interested the consumer is in a given product or service.

10. The computing system implemented process for providing dynamically customized marketing devices using real-time consumer data of claim 6, wherein;
the automatically transformed one or more marketing devices include a mobile coupon.

11. A system for providing dynamically customized marketing devices using real-time consumer data comprising:
a consumer mobile computing system, the mobile computing system being associated with a consumer;
a marketing device access application implemented, at least in part, on the consumer computing system;
a database;
data representing one or more marketing devices, the data representing one or more marketing devices being stored in the database; and
one or more processors associated with one or more computing systems, the one or more processors executing instructions associated with a process for providing dynamically customized marketing devices, the process for providing dynamically customized marketing devices comprising:
obtaining data related to the current shopping related activity of the consumer from the mobile computing system associated with the consumer and one or more of the consumer's interactions with the mobile computing system associated with the consumer;
using the one or more processors associated with one or more computing systems to analyze and transform the data related to the current shopping related activity of a consumer into current shopping analytics data associated with the consumer indicating one or more current shopping circumstances associated with the consumer;
using the one or more processors associated with one or more computing systems to automatically generate one or more marketing devices based, at least in part, on the current shopping analytics data associated with the consumer indicating one or more current shopping circumstances associated with the consumer; and
providing data representing the one or more marketing devices to the consumer through the mobile computing system associated with the consumer.

12. The system for providing dynamically customized marketing devices using real-time consumer data of claim 11, wherein;
the mobile computing system associated with the consumer is a mobile telephone or smart phone.

13. The system for providing dynamically customized marketing devices using real-time consumer data of claim 11, wherein;
the data related to the current shopping related activity of a consumer obtained from a mobile computing system associated with the consumer and one or more of the consumer's interactions with the mobile computing system associated with the consumer includes one or more data selected from the group of data consisting of:
data indicating marketing device searches the consumer has recently conducted, and/or is conducting, using the mobile computing system associated with the consumer;
data indicating the marketing devices the consumer has recently accessed, viewed, and/or downloaded, and/or is currently accessing, viewing, and/or downloading using the mobile computing system associated with the consumer;
data indicating recent marketing device redemptions made by the consumer, and/or redemptions currently being made by the consumer, using the mobile computing system associated with the consumer;
data indicating network and/or website searches recently conducted by, or being conducted by, the consumer using the mobile computing system associated with the consumer; data indicating historical purchase behavior/events associated with the consumer involving the current merchant and/or product or other merchants and/or products;
data indicating various financial data associated with the consumer;
data indicating a date and/or time of day;
camera and/or other video data currently, or recently, recorded by the consumer using the mobile computing system;
data indicating the consumers distance from alternative merchants and/or products; and
current GPS/location data for the consumer obtained from, or provided to, the mobile computing system associated with the consumer.

14. The system for providing dynamically customized marketing devices using real-time consumer data of claim 11, wherein;
the current shopping analytics data associated with the consumer indicating one or more current shopping circumstances associated with the consumer includes one or more current shopping analytics data associated with the consumer indicating one or more current shopping circumstances associated with the consumer selected from the group of current shopping analytics data associated with the consumer indicating one or more current shopping circumstances associated with the consumer consisting of:
data indicating what types of products the consumer is currently considering purchasing;
data indicating products related to the types of products the consumer is currently considering purchasing;
data indicating what marketing devices and/or offers are currently being offered to, and/or considered by, the consumer;
data indicating the terms of the marketing devices and/or offers currently being offered to, and/or considered by, the consumer;
data indicating the physical location of the consumer;
data indicating how close the consumer is to actually making a purchase decision; and
data indicating how carefully the consumer is considering a given purchase and how interested the consumer is in a given product or service.

15. The system for providing dynamically customized marketing devices using real-time consumer data of claim 11, wherein;
the automatically generated one or more marketing devices include a mobile coupon.

16. A system for providing dynamically customized marketing devices using real-time consumer data comprising:
a consumer mobile computing system, the mobile computing system being associated with a consumer;
a marketing device access application implemented, at least in part, on the consumer computing system;
a database;
data representing one or more marketing devices, the data representing one or more marketing devices being stored in the database; and
one or more processors associated with one or more computing systems, the one or more processors executing instructions associated with a process for providing dynamically customized marketing devices, the process for providing dynamically customized marketing devices comprising:
obtaining data related to the current shopping related activity of the consumer from the mobile computing system associated with the consumer and one or more of the consumer's interactions with the mobile computing system associated with the consumer;
using the one or more processors associated with one or more computing systems to analyze and transform the data related to the current shopping related activity of a consumer into current shopping analytics data associated with the consumer indicating one or more current shopping circumstances associated with the consumer;
using the one or more processors associated with one or more computing systems to automatically transform data representing one or more marketing devices in the database based, at least in part, on the current shopping analytics data associated with the consumer indicating one or more current shopping circumstances associated with the consumer; and
providing data representing the one or more transformed marketing devices to the consumer through the mobile computing system associated with the consumer.

17. The system for providing dynamically customized marketing devices using real-time consumer data of claim 16, wherein;
the mobile computing system associated with the consumer is a mobile telephone or smart phone.

18. The system for providing dynamically customized marketing devices using real-time consumer data of claim 16, wherein;
the data related to the current shopping related activity of a consumer obtained from a mobile computing system associated with the consumer and one or more of the consumer's interactions with the mobile computing system associated with the consumer includes one or more data selected from the group of data consisting of:
data indicating marketing device searches the consumer has recently conducted, and/or is conducting, using the mobile computing system associated with the consumer;
data indicating the marketing devices the consumer has recently accessed, viewed, and/or downloaded, and/or is currently accessing, viewing, and/or downloading using the mobile computing system associated with the consumer;
data indicating recent marketing device redemptions made by the consumer, and/or redemptions currently being made by the consumer, using the mobile computing system associated with the consumer;
data indicating network and/or website searches recently conducted by, or being conducted by, the consumer using the mobile computing system associated with the consumer; data indicating historical purchase behavior/events associated with the consumer involving the current merchant and/or product or other merchants and/or products;
data indicating various financial data associated with the consumer;
data indicating a date and/or time of day;
camera and/or other video data currently, or recently, recorded by the consumer using the mobile computing system;
data indicating the consumers distance from alternative merchants and/or products; and
current GPS/location data for the consumer obtained from, or provided to, the mobile computing system associated with the consumer.

19. The system for providing dynamically customized marketing devices using real-time consumer data of claim 16, wherein;
the current shopping analytics data associated with the consumer indicating one or more current shopping circumstances associated with the consumer includes one or more current shopping analytics data associated with the consumer indicating one or more current shopping circumstances associated with the consumer selected from the group of current shopping analytics data associated with the consumer indicating one or more current shopping circumstances associated with the consumer consisting of:
data indicating what types of products the consumer is currently considering purchasing;
data indicating products related to the types of products the consumer is currently considering purchasing;
data indicating what marketing devices and/or offers are currently being offered to, and/or considered by, the consumer;
data indicating the terms of the marketing devices and/or offers currently being offered to, and/or considered by, the consumer;
data indicating the physical location of the consumer;
data indicating how close the consumer is to actually making a purchase decision; and
data indicating how carefully the consumer is considering a given purchase and how interested the consumer is in a given product or service.

20. The system for providing dynamically customized marketing devices using real-time consumer data of claim 16, wherein;
the automatically transformed one or more marketing devices include a mobile coupon.

21. A method for providing dynamically customized marketing devices using real-time consumer data comprising:
obtaining data related to the current shopping related activity of a consumer from a mobile computing system associated with the consumer and one or more of the consumer's interactions with the mobile computing system associated with the consumer;
analyzing and transforming the data related to the current shopping related activity of a consumer into current shopping analytics data associated with the consumer indicating one or more current shopping circumstances associated with the consumer;
automatically generating one or more marketing devices, the terms of the one or more marketing devices being based, at least in part, on the current shopping analytics data associated with the consumer indicating one or more current shopping circumstances associated with the consumer; and
providing data representing the one or more marketing devices to the consumer through the mobile computing system associated with the consumer.

22. The method for providing dynamically customized marketing devices using real-time consumer data of claim 21, wherein;
the mobile computing system associated with the consumer is a mobile telephone or smart phone.

23. The method for providing dynamically customized marketing devices using real-time consumer data of claim 21, wherein;
the data related to the current shopping related activity of a consumer obtained from a mobile computing system associated with the consumer and one or more of the consumer's interactions with the mobile computing system associated with the consumer includes one or more data selected from the group of data consisting of:
data indicating marketing device searches the consumer has recently conducted, and/or is conducting, using the mobile computing system associated with the consumer;
data indicating the marketing devices the consumer has recently accessed, viewed, and/or downloaded, and/or is currently accessing, viewing, and/or downloading using the mobile computing system associated with the consumer;
data indicating recent marketing device redemptions made by the consumer, and/or redemptions currently being made by the consumer, using the mobile computing system associated with the consumer;
data indicating network and/or website searches recently conducted by, or being conducted by, the consumer using the mobile computing system associated with the consumer;
data indicating historical purchase behavior/events associated with the consumer involving the current merchant and/or product or other merchants and/or products;
data indicating various financial data associated with the consumer;
data indicating a date and/or time of day;
camera and/or other video data currently, or recently, recorded by the consumer using the mobile computing system;
data indicating the consumers distance from alternative merchants and/or products; and
current GPS/location data for the consumer obtained from, or provided to, the mobile computing system associated with the consumer.

24. The method for providing dynamically customized marketing devices using real-time consumer data of claim 21, wherein;
the current shopping analytics data associated with the consumer indicating one or more current shopping circumstances associated with the consumer includes one or more current shopping analytics data associated with the consumer indicating one or more current shopping circumstances associated with the consumer selected from the group of current shopping analytics data associated with the consumer indicating one or more current shopping circumstances associated with the consumer consisting of:
data indicating what types of products the consumer is currently considering purchasing;
data indicating products related to the types of products the consumer is currently considering purchasing;
data indicating what marketing devices and/or offers are currently being offered to, and/or considered by, the consumer;
data indicating the terms of the marketing devices and/or offers currently being offered to, and/or considered by, the consumer;
data indicating the physical location of the consumer;
data indicating how close the consumer is to actually making a purchase decision; and
data indicating how carefully the consumer is considering a given purchase and how interested the consumer is in a given product or service.

25. The method for providing dynamically customized marketing devices using real-time consumer data of claim 21, wherein;
the automatically generated one or more marketing devices include a mobile coupon.

26. A method for providing dynamically customized marketing devices using real-time consumer data comprising:
obtaining data related to the current shopping related activity of a consumer from a mobile computing system associated with the consumer and one or more of the consumer's interactions with the mobile computing system associated with the consumer;
analyzing and transforming the data related to the current shopping related activity of a consumer into current shopping analytics data associated with the consumer indicating one or more current shopping circumstances associated with the consumer;
automatically transforming one or more marketing devices based, at least in part, on the current shopping analytics data associated with the consumer indicating one or more current shopping circumstances associated with the consumer; and
providing data representing the one or more transformed marketing devices to the consumer through the mobile computing system associated with the consumer.

27. The method for providing dynamically customized marketing devices using real-time consumer data of claim 26, wherein;
the mobile computing system associated with the consumer is a mobile telephone or smart phone.

28. The method for providing dynamically customized marketing devices using real-time consumer data of claim 26, wherein;
the data related to the current shopping related activity of a consumer obtained from a mobile computing system associated with the consumer and one or more of the consumer's interactions with the mobile computing system associated with the consumer includes one or more data selected from the group of data consisting of:
data indicating marketing device searches the consumer has recently conducted, and/or is conducting, using the mobile computing system associated with the consumer;
data indicating the marketing devices the consumer has recently accessed, viewed, and/or downloaded, and/or is currently accessing, viewing, and/or downloading using the mobile computing system associated with the consumer;
data indicating recent marketing device redemptions made by the consumer, and/or redemptions currently being made by the consumer, using the mobile computing system associated with the consumer;
data indicating network and/or website searches recently conducted by, or being conducted by, the consumer using the mobile computing system associated with the consumer; data indicating historical purchase behavior/events associated with the consumer involving the current merchant and/or product or other merchants and/or products;
data indicating various financial data associated with the consumer;
data indicating a date and/or time of day;
camera and/or other video data currently, or recently, recorded by the consumer using the mobile computing system;
data indicating the consumers distance from alternative merchants and/or products; and
current GPS/location data for the consumer obtained from, or provided to, the mobile computing system associated with the consumer.

29. The method for providing dynamically customized marketing devices using real-time consumer data of claim 26, wherein;
the current shopping analytics data associated with the consumer indicating one or more current shopping circumstances associated with the consumer includes one or more current shopping analytics data associated with the consumer indicating one or more current shopping circumstances associated with the consumer selected from the group of current shopping analytics data associated with the consumer indicating one or more current shopping circumstances associated with the consumer consisting of:
data indicating what types of products the consumer is currently considering purchasing;
data indicating products related to the types of products the consumer is currently considering purchasing;
data indicating what marketing devices and/or offers are currently being offered to, and/or considered by, the consumer;
data indicating the terms of the marketing devices and/or offers currently being offered to, and/or considered by, the consumer;
data indicating the physical location of the consumer;
data indicating how close the consumer is to actually making a purchase decision; and
data indicating how carefully the consumer is considering a given purchase and how interested the consumer is in a given product or service.

30. The method for providing dynamically customized marketing devices using real-time consumer data of claim 26, wherein;
the automatically transformed one or more marketing devices include a mobile coupon.
